(19) United States
(12) Patent Application Publication
(10) Pub. No.: US 2025/0151028 A1
(43) Pub. Date: May 8, 2025

(54) PAGING-ASSISTED MESSAGE DELIVERY USING AIRCRAFT-BASED MOBILE RELAY

(71) Applicant: QUALCOMM Incorporated, San Diego, CA (US)

(72) Inventors: Kangqi LIU, San Diego, CA (US); Alexei Yurievitch GOROKHOV, San Diego, CA (US); Ruiming ZHENG, Beijing (CN); Chao WEI, Beijing (CN); Qiaoyu LI, Beijing (CN); Mingxi YIN, Beijing (CN); Hao XU, Beijing (CN)

(21) Appl. No.: 18/837,079

(22) PCT Filed: Apr. 20, 2022
(86) PCT No.: PCT/CN2022/087844

§ 371 Date: Aug. 8, 2024

(51) Int. Cl. H04W 68/02; H04W 24/08; H04W 68/12; H04W 76/27; H04W 84/06; H04W 88/04

(52) U.S. Cl. CPC H04W 68/02; H04W 24/08; H04W 68/12; H04W 76/27; H04W 84/06; H04W 88/04

(57) ABSTRACT

A terrestrial UE may receive at least one of a PEI or a paging indication based on a configuration for a search space associated with the at least one of the PEI or the paging indication and transmit a message to a network node via an aircraft-based relay node based on the at least one of the PEI or the paging indication. The relay node may transmit the at least one of the PEI or the paging indication to the terrestrial UE or receive the at least one of the PEI or the paging indication from an NTN device. The relay node may receive the message from the terrestrial UE based on the at least one of the PEI or the paging indication and relay the message to the network node after receiving the message from the terrestrial UE.

### TECHNICAL FIELD

The present disclosure relates generally to communication systems, and more particularly, to message delivery using an aircraft-based mobile relay.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE) that may receive at least one of a paging early indication (PEI) or a paging indication based on a configuration for a search space associated with the at least one of the PEI or the paging indication; and transmit a message to a network node via a relay node based on the at least one of the PEI or the paging indication.

In another aspect of the disclosure, a method, a computer-readable medium, and an apparatus are provided. The apparatus may be a relay node that may transmit, to a terrestrial UE, or receive, from a non-terrestrial network (NTN) device, at least one of a PEI or a paging indication based on a configuration for a search space associated with the at least one of the PEI or the paging indication; receive a message from the terrestrial UE based on the at least one of the PEI or the paging indication; and relay the message to a network node after receiving the message from the terrestrial UE.

In yet another aspect of the disclosure, a method, a computer-readable medium, and an apparatus are provided. The apparatus may be an NTN device that may receive a configuration for a search space associated with at least one of a paging early indication (PEI) or a paging indication from a network node, the configuration being received based on at least one of a direct communication from the network node to the NTN device or an indirect communication from the network node to the NTN device via a relay node; and transmit the at least one of the PEI or the paging indication to a terrestrial UE based on the configuration for the search space associated with the at least one of the PEI or the paging indication.

In still another aspect of the disclosure, a method, a computer-readable medium, and an apparatus are provided. The apparatus may be a network node that may transmit a configuration for a search space associated with at least one of a PEI or a paging indication to at least one of a relay node or an NTN device, the configuration being transmitted based on at least one of a first direct transmission from the network node to the relay node, a second direction transmission from the network node to the NTN device, a first indirect transmission to the relay node via the NTN device, or a second indirect transmission to the NTN device via the relay node; and receive a message from a terrestrial UE via the relay node based on the configuration for the search space associated with the at least one of the PEI or the paging indication.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram that illustrates signaling between entities of a network associated with air-to-ground (ATG) communications.

FIG. 5 is a flow diagram illustrating communications between a terrestrial UE, a relay node, and a non-terrestrial network (NTN) device for paging-assisted message delivery.

FIG. 6 is a flow diagram illustrating communications between a terrestrial UE, a relay node, and an NTN device for paging-assisted message delivery.

FIG. 7 is a flow diagram illustrating communications between a terrestrial UE, a relay node, and an NTN device for paging-assisted message delivery.

FIG. 8 is a call flow diagram illustrating communications between a UE and a relay node.

FIG. 9 is a flowchart of a method of wireless communication at a UE.

FIG. 10 is a flowchart of a method of wireless communication at a UE.

FIG. 11 is a flowchart of a method of wireless communication at a relay node.

FIG. 12 is a flowchart of a method of wireless communication at a relay node.

FIG. 13 is a flowchart of a method of wireless communication at a network node.

FIG. 14 is a flowchart of a method of wireless communication at a network node.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

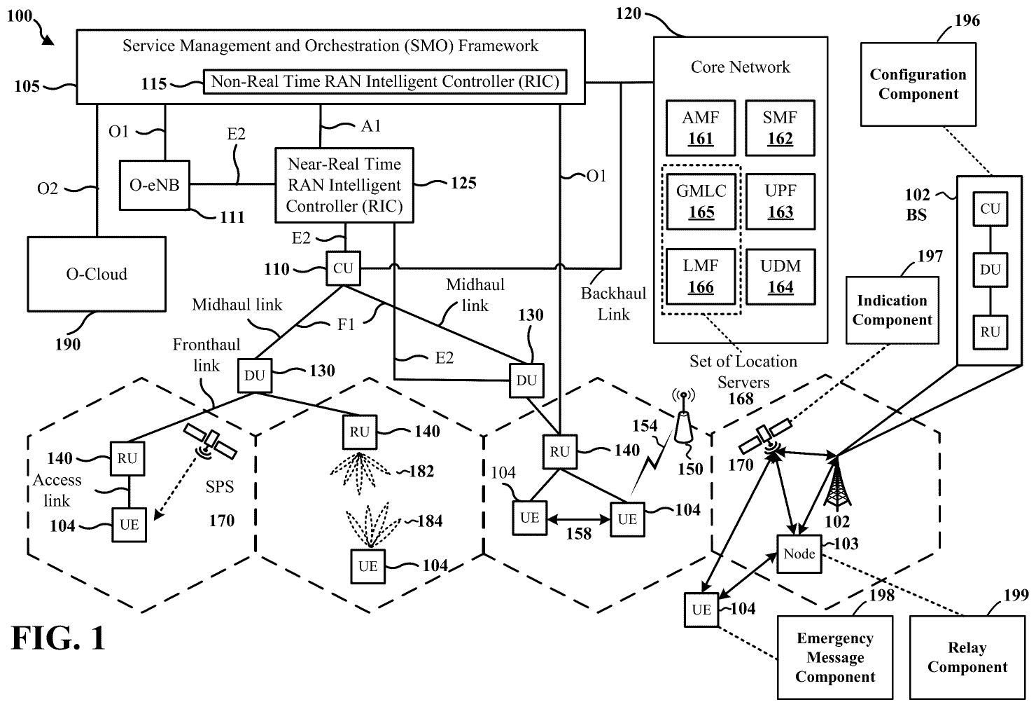

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective user equipments (UEs) 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node 103, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an emergency message component 198 configured to receive at least one of a paging early indication (PEI) or a paging indication based on a configuration for a search space associated with the at least one of the PEI or the paging indication; and transmit a message to a network node via a relay node based on the at least one of the PEI or the paging indication. In certain aspects, the relay node 103 may include a relay component 199 configured to transmit, to a terrestrial UE, or receive, from an NTN device, at least one of a PEI or a paging indication based on a configuration for a search space associated with the at least one of the PEI or the paging indication; receive a message from the terrestrial UE based on the at least one of the PEI or the paging indication; and relay the message to a network node after receiving the message from the terrestrial UE.

In certain aspects, the SPS 170 or a network entity of the SPS 170 may include an indication component 197 configured to receive a configuration for a search space associated with at least one of a PEI or a paging indication from a network node, the configuration being received based on at least one of a direct communication from the network node to the NTN device or an indirect communication from the network node to the NTN device via a relay node; and transmit the at least one of the PEI or the paging indication to a terrestrial UE based on the configuration for the search space associated with the at least one of the PEI or the paging indication. In certain aspects, the base station 102 or a network entity of the base station 102 may include a configuration component 196 configured to transmit a configuration for a search space associated with at least one of a PEI or a paging indication to at least one of a relay node or an NTN device, the configuration being transmitted based on at least one of a first direct transmission from the network node to the relay node, a second direction transmission from the network node to the NTN device, a first indirect transmission to the relay node via the NTN device, or a second indirect transmission to the NTN device via the relay node; and receive a message from a terrestrial UE via the relay node based on the configuration for the search space associated with the at least one of the PEI or the paging indication. Although the following description may be focused on 5G NR, the concepts described herein may be applicable to other similar areas, such as LTE, LTE-A, CDMA, GSM, and other wireless technologies.

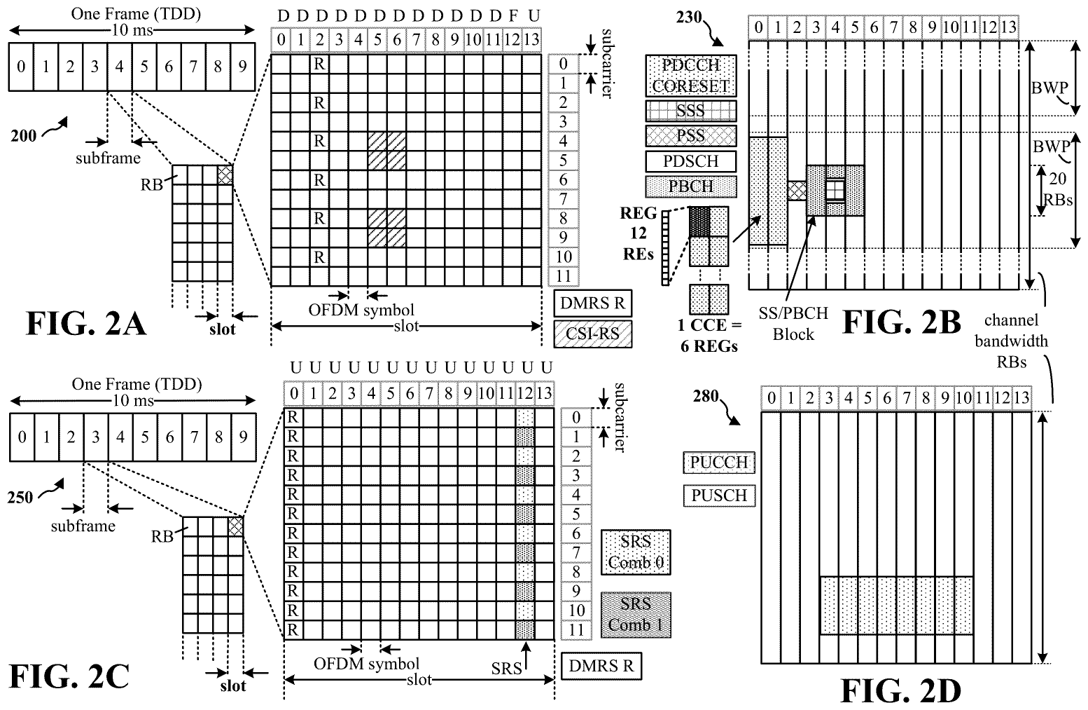

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2μ · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

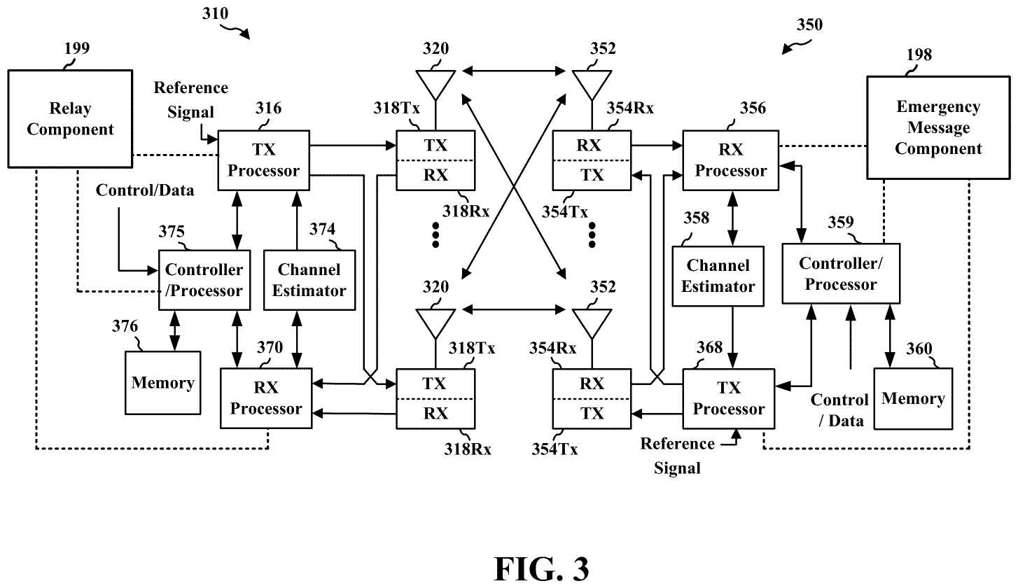

FIG. 3 is a block diagram of a relay node 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the relay node 310. These soft decisions may be based on channel estimates computed by the channel estimator 358. The soft decisions are then decoded and deinterleaved to recover the data and control signals that were originally transmitted by the relay node 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the relay node 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the relay node 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the relay node 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the emergency message component 198 of FIG. 1.

At least one of the TX processor 316, the RX processor 370, and the controller/processor 375 may be configured to perform aspects in connection with the relay component 199 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and ultra-reliable low latency communication (URLLC) may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

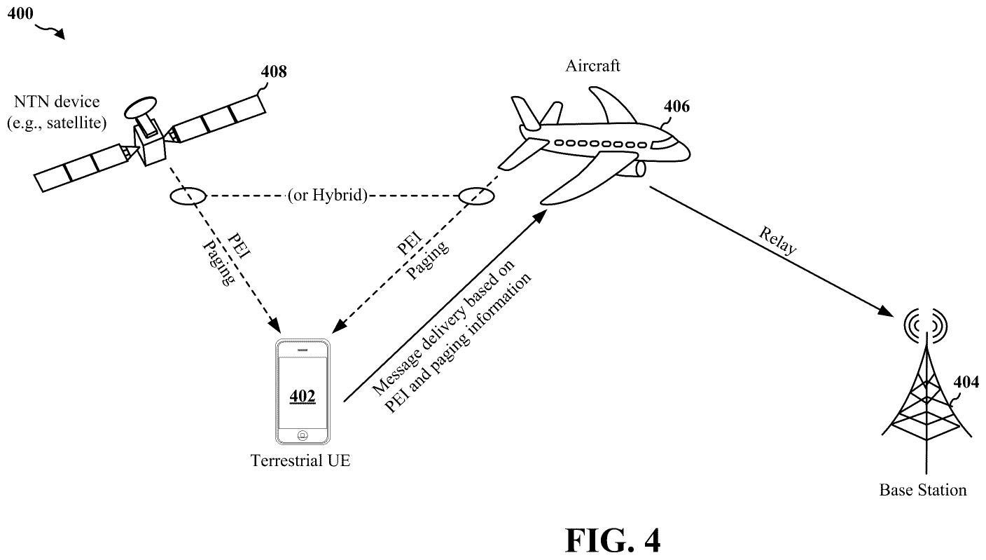

FIG. 4 is a diagram 400 that illustrates signaling between entities of a network associated with air-to-ground (ATG) communications. A message transmitted from a terrestrial UE 402, such as an emergency message, may have a higher priority than other types of communications transmitted by the terrestrial UE 402. In cases where the terrestrial UE is outside a cellular coverage area of a base station 404 (e.g., terrestrial base station), the terrestrial UE 402 may communicate the emergency message based on ATG techniques. For example, the terrestrial UE 402 may be configured to transmit the emergency message to an NTN device 408, such as a satellite, which may relay the emergency message to the base station 404, which may not have the terrestrial UE 402 within a coverage area of the base station 404.

By utilizing the NTN device 408 associated with satellite technology, which may already be in operation, time-to-market costs and deployment costs may be reduced for emergency messaging techniques of the terrestrial UE 402. However, antenna conditions and/or transmit power conditions associated with NTN communications may have reduced efficiencies. For instance, human assistance may be involved to point the antenna of the terrestrial UE 402 towards the NTN device 408 or to avoid a blockage between the NTN device 408 and the terrestrial UE 402. Such conditions may also reduce a capability of the terrestrial UE 402 to transmit certain messages (e.g., machine type communication (MTC) messages). While some NTN communication procedures may increase non-terrestrial communication efficiencies, deployment costs for the increased efficiencies, such as launching additional satellites/NTN devices 408, establishing additional gateways, etc., may also be increased. Further, business models associated with mobile connections to the NTN device 408 may not be economically viable, and may therefore prolong the deployment of such systems.

ATG communications may correspond to different land and/or coastal conditions. For instance, deployment of ATG systems (e.g., in-land or along coastal regions) may be based on antenna up-tilting at terrestrial base stations, such as the base station 404. Antenna up-tilting may allow signals transmitted from the base station 404 to be pointed in a direction of an aircraft 406 and may further allow the signals to be propagated to an aircraft-based receiver over an increased distance. Signals transmitted from the base station 404 based on antenna up-tilting may be propagated to the aircraft 406 at distances of over 200 km, based on a cruising altitude of the aircraft 406 being 13 km.

The aircraft 406 may communicate with different base stations on the ground as the aircraft 406 flies over respective cells of the different base stations. In coastal areas, the aircraft 406 may proceed over large bodies of water to locations that are outside a range of the base station 404. The aircraft 406 may continue to communicate with the closest base station, such as the base station 404, until the aircraft 406 loses contact with the closest base station over a ground-based communication link. When the aircraft 406 approaches land again and is within a communication range of another base station, the aircraft 406 may reestablish a ground-based communication link with the other base station. In examples, an antenna of an aircraft-based UE may be located at a bottom or a side of the aircraft 406 for increased signal reception. Aircraft-based devices may also be in communication with customer premise equipment (CPE) included at the aircraft 406.

In comparison to satellite communications, aircraft-based communications may have a lower cost, a higher throughput, and/or a lower latency than satellite communications. Traffic types for aircraft-based communications may include in-flight passenger communications, airline operation communications, air traffic control communications, etc. In-flight passenger communications may be used for in-route commercial flights, business aviation, climbing or descending periods, takeoff/landing, etc. Airline operation communications may be used for aircraft maintenance, flight planning, weather information, etc. Air traffic control communications may be used as a back-up to systems in aviation licensed bands, etc.

ATG communication deployments may be based on NR communication techniques, but may also include ATG-specific enhancements. For example, particular routes for the aircraft 406 may be associated with particular base stations, core networks, and/or wireless network management procedures. Aircraft-based deployments may also be associated with regulated procedures for the aircraft 406 to improve ATG communications. Some aircraft regulations may be based on dedicated ATG protocols for ATG communications (e.g., system protocols, protocols associated with a frequency spectrum, multi-user communication protocols, etc.). Globally inter-operable deployments for ATG communications may also be enabled based on predefined/dedicated ATG protocols.

Commercial aircrafts, such as the aircraft 406, may provide an opportunistic channel for the terrestrial UE 402 that is outside the coverage area of the base station 404 to transmit a message to the base station 404. A relay node may be incorporated at the aircraft 406 flying above the terrestrial UE 402, where the relay node may be configured to relay the message (e.g., emergency message) transmitted from the terrestrial UE 402 to the base station 404. In examples, the relay node may correspond to a non-terrestrial base station, a non-terrestrial IAB node, a non-terrestrial UE (e.g., non-terrestrial relay UE), etc., based on different configurations. While the terrestrial UE 402 may be outside the coverage area of the base station 404, both the terrestrial UE 402 and the base station 404 may be within a line-of-sight of the aircraft 406 that includes the relay node for relaying one or more communications between the terrestrial UE 402 and the base station 404.

One or more relay nodes incorporated at the aircraft 406 may extend a coverage of the terrestrial UE 402, which may not be in current communication with the base station 404. Relay node refers to a network node/entity that relays or forwards communication from one device to another device, such that the relay node may extend a coverage of the devices. In examples, the relay node may correspond to a base station or an IAB node, such as when the relay node is used to transmit a PEI and/or a paging indication, or the relay node may also correspond to a UE, such as when the relay node is not used to transmit the PEI and/or the paging indication. A cruising altitude for the aircraft 406 may be approximately 10-13 km and may allow for line-of-sight signal propagation of over 200 km. An aerial density of aircrafts in the sky may vary region-by-region and/or based on a time of day. For example, flight patterns may be of increased density during an afternoon time than during a night time. However, there is often at least one line-of-sight/visible aircraft 406 within 50-100 km of a terrestrial UE 402, even in major remote areas, at most times of the day in many countries.

ATG communications may reduce a dependency on launching additional satellites/NTN devices 408, and may therefore provide decreased deployment costs. For instance, deployment costs for ATG communications may include software upgrades to ATG CPEs, which may also have a faster time-to-market than NTN devices 408. Further, less human assistance may be involved with device operations associated with ATG communications. MTC messages may also be communicated based on predefined protocols for such messaging techniques. However, interference may be generated in some cases toward terrestrial systems, such as the base station 404 and/or the terrestrial UE 402, as some terrestrial communications may utilize a same frequency band as the ATG communications.

A message transmission from the terrestrial UE 402, such as an emergency message, may be initiated by terrestrial UE 402, which may be outside the coverage area of the base station 404. Allowing the terrestrial UE 402 to initiate emergency message transmissions in a reserved resource may allow the aircraft-based UE to avoid actively transmitting signals that may have to be discovered by mobile devices, such as the terrestrial UE 402. By refraining from transmitting active discovery signals, interference towards terrestrial systems/devices, such as the base station 404 and/or the terrestrial UE 402, may be reduced. However, such techniques may cause an increased amount of power to be consumed at the terrestrial UE 402, which may have to scan for the discovery signals. Aircraft-initiated discovery signal transmissions may be based on the aircraft-based UE continuously broadcasting discovery announcement signals/SSBs, as the aircraft-based UE may not be aware of the terrestrial UE 402 that is outside the cellular coverage area of the base station 404. Given that the discovery signal transmissions may cover a wide area, some of the discovery signal transmissions may cause interference to terrestrial communications between the base station 404 and other devices.

A paging-assisted emergency message communication procedure may be used to both reduce the power consumption at the terrestrial UE 402 as well as reduce interference towards terrestrial communications. If an aircraft 406 that supports an emergency message relay service is flying within a communication range of the terrestrial UE 402 and the aircraft 406 is also in communication with the base station 404 (e.g., within a direct communication range of the base station 404 or an indirect communication range of the base station 404 via the NTN device 408 or other devices), a PEI or a paging indication may be transmitted for the terrestrial UE 402. The PEI/paging indication may refer to dedicated signaling for an emergency message relay service associated with a relay node at the aircraft 406. The transmission may avoid blind UE-initiated emergency message transmissions, which may reduce the power consumption at the terrestrial UE 402. That is, reception of the PEI may correspond to a lower power consumption at the terrestrial UE 402 than a paging PDCCH decoding procedure and/or an SSB monitoring procedure.

In examples, the PEI and the paging indication may be transmitted to the terrestrial UE 402 by the NTN device 408, which may correspond to a satellite, a high altitude platform station (HAPS), etc. In further examples, the PEI and the paging indication may be transmitted to the terrestrial UE 402 based on a hybrid technique, where one of the PEI or the paging indication is transmitted to the terrestrial UE 402 from the aircraft 406 and the other one of the PEI or the paging indication is transmitted to the terrestrial UE 402 from the NTN device 408. If both the PEI and the paging indication is transmitted by the NTN device 408 (e.g., a satellite) to the terrestrial UE 402, there may be no aircraft-to-UE communication link for reducing the interference to terrestrial communications. That is, NTN communications may be based on a dedicated spectrum that is different from the terrestrial network, while ATG communications may be based on the same spectrum. In other examples, both the PEI and the paging indication may be transmitted from the aircraft 406 to the terrestrial UE 402. Based on reception of the PEI and the paging indication from the aircraft 406 and/or the NTN device 408, the terrestrial UE may transmit a message to a relay node located at the aircraft 406, which may relay the message to the base station 404.

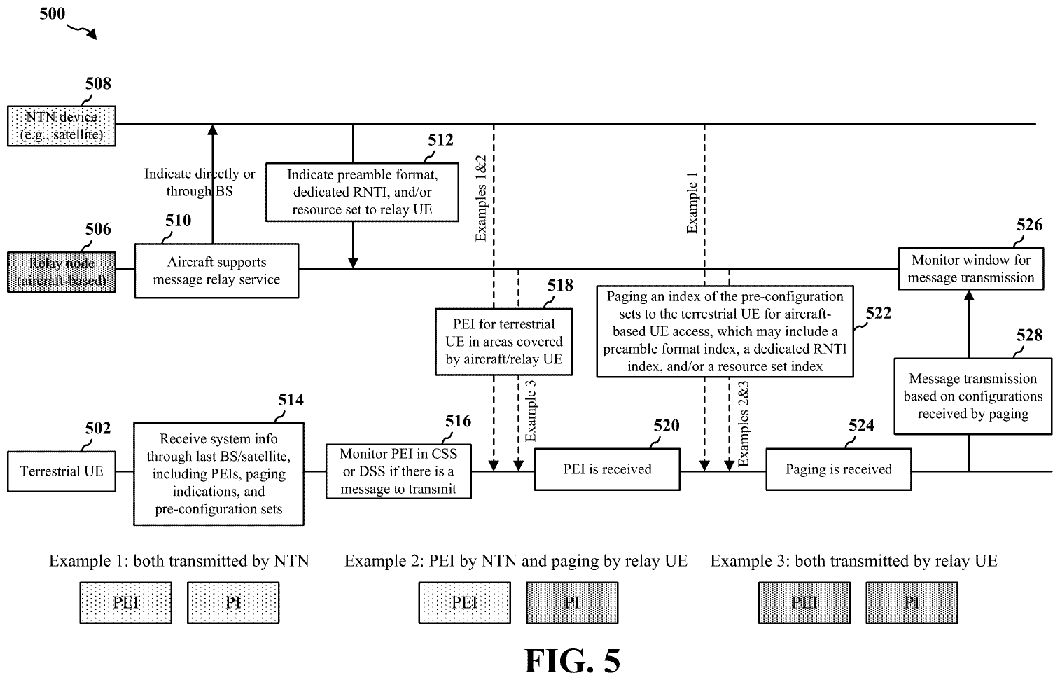

FIG. 5 is a flow diagram 500 illustrating communications between a terrestrial UE 502, a relay node 506 (e.g., aircraft-based UE), and an NTN device 508 (e.g., satellite) for paging-assisted message delivery. If the relay node 506 is located at an aircraft that supports a message relay service (e.g., emergency message relay service) between the terrestrial UE 502 and a base station, the relay node 506 may indicate, at 510, to the NTN device 508 that the relay node 506 supports the message relay service. The relay node 506 may transmit the indication, at 510, directly to the NTN device 508 or indirectly to the NTN device 508 via a base station. Based on the indication received, at 510, from the relay node 506, the NTN device 508 may indicate, at 512, a preamble format, a dedicated radio network temporary identifier (RNTI), and/or a resource set to the relay node 506 located at the aircraft. Hence, the relay node 506 may be configured by the NTN device 508, which may include a configuration to transmit PEIs and/or paging indications to the terrestrial UE 502 when the aircraft is flying within a range of the terrestrial UE 502.

The terrestrial UE 502 may receive, at 514, system information from a last base station or a last satellite/NTN device 508 with which the terrestrial UE 502 was in an RRC_connected state. For example, the terrestrial UE 502 may receive, at 514, system information indicative of PEIs, paging indications, pre-configuration sets, etc. A common search space (CSS) or a dedicated search space (DSS) for an emergency-Msg-Aircraft-Relaying-PEI (e.g., the PEI transmitted from the aircraft 406 to the terrestrial UE 402 in FIG. 4) may be configured to the terrestrial UE 502 through RRC signaling or a MAC control element (CE) (MAC-CE) prior to the terrestrial UE 502 switching from the RRC_connected state to a current RRC_idle state or a current RRC_inactive state. MAC-CE corresponds to a special MAC structure that carries control information. The configuration to the terrestrial UE 502 of the emergency-Msg-Aircraft-Relaying-PEI and/or an associated paging indication configuration may be received by the terrestrial UE 502 when the aircraft that supports the message relay service is flying within the range of the terrestrial UE 502.

If the terrestrial UE 502 has a message (e.g., emergency message) to transmit to the base station while the terrestrial UE 502 is outside a coverage area of the base station, the terrestrial UE 502 may monitor, at 516, for the emergency-Msg-Aircraft-Relaying-PEI. The terrestrial UE 502 may monitor, at 516, for the PEI in the CSS or the DSS configured to the terrestrial UE 502 by the last base station or the last satellite/NTN device 508 with which the terrestrial UE 502 was in the RRC_connected state. The monitoring, at 516, may be based on a determination at the terrestrial UE 502 to transmit a relayed message to the base station, such that the terrestrial UE 502 may conserve battery power consumed by monitoring for PEIs at times when the terrestrial UE 502 does not have a relayed message to transmit to the base station.

The terrestrial UE 502 may receive the PEI, at 520, and the paging indication, at 524, based on different PEI/paging transmission techniques. In a first example, both the PEI and the paging indication may be transmitted from the NTN device 508 to the terrestrial UE 502. In a second example, the PEI may be transmitted from the NTN device 508 to the terrestrial UE 502 and the paging indication may be transmitted from the relay node 506 to the terrestrial UE 502. In a third example, both the PEI and the paging indication may be transmitted from the relay node 506 to the terrestrial UE 502.

The PEI for the terrestrial UE 502 may be transmitted, at 518, in areas that are covered by the aircraft/relay node 506. If the PEI is transmitted, at 518, by the NTN device 508, the relay node 506 may indicate a location of the aircraft to the NTN device 508 for PEI transmission to the terrestrial UE 502. The PEI may be received, at 520, by the terrestrial UE 502 from either the relay node 506 or the NTN device 508. The paging indication for the terrestrial UE 502 may be transmitted, at 522, to the terrestrial UE 502 following transmission/reception of the PEI, at 518-520. The paging indication transmitted, at 522, to the terrestrial UE 502 may be indicative of an index of the pre-configuration sets for aircraft-based UE access by the terrestrial UE 502. The index may correspond to a preamble format index, a dedicated RNTI index, and/or a resource set index, which may be used for emergency message transmissions. The paging indication may be received, at 524, by the terrestrial UE 502 from either the relay node 506 or the NTN device 508. Pre-configuration and indexing techniques may be used for paging indications with decreased payload sizes.

The relay node 506 may initiate, at 526, a monitoring window for a message transmission from the terrestrial UE 502 based on transmission, at 518, of the PEI and transmission, at 522, of the paging indication. Aircrafts within a range of each other may utilize different preamble formats, different RNTIs, different resource sets, etc., to avoid ATG communication collisions. At 528, the terrestrial UE 502 may transmit the message (e.g., emergency message) to the relay node 506 located at the aircraft based on the configurations received, at 522, via the paging indication. The relay node 506 may relay the message transmission from the terrestrial UE 502 to the base station.

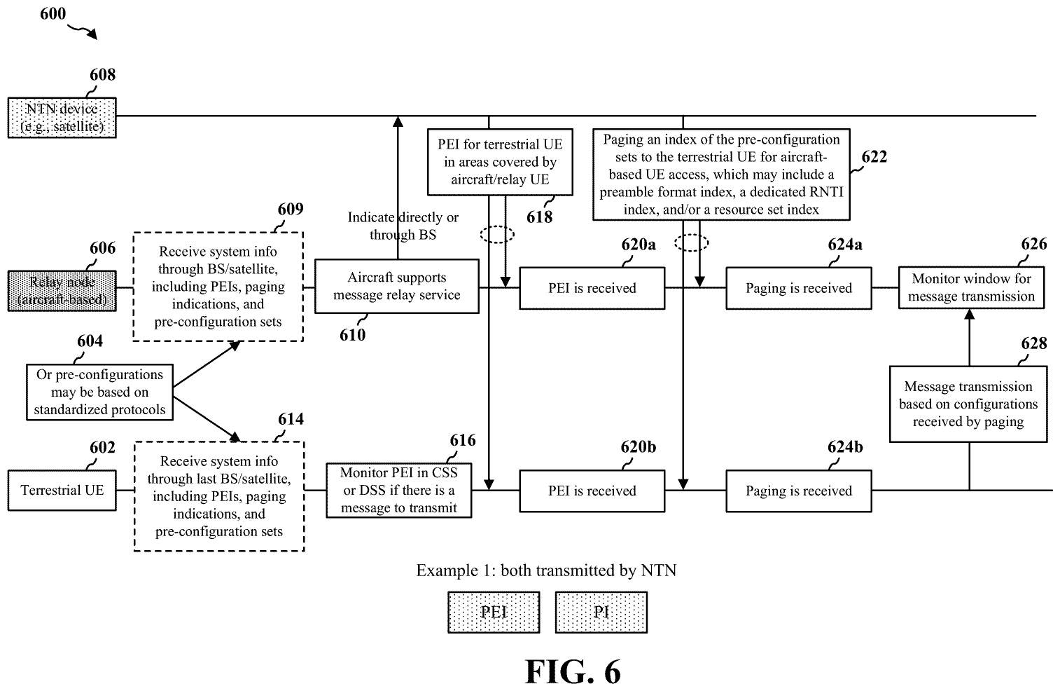

FIG. 6 is a flow diagram 600 illustrating communications between a terrestrial UE 602, a relay node 606 (e.g., aircraft-based UE), and an NTN device 608 (e.g., satellite) for paging-assisted message delivery. The terrestrial UE 602 may receive, at 614, system information from a last base station or a last satellite/NTN device 608 with which the terrestrial UE 602 was in an RRC_connected state. For example, the terrestrial UE 602 may receive, at 614, system information indicative of PEIs, paging indications, pre-configuration sets, etc. A CSS or a DSS for an emergency-Msg-Aircraft-Relaying-PEI may be configured to the terrestrial UE 602 through RRC signaling or a MAC-CE prior to the terrestrial UE 602 switching from the RRC_connected state to a current RRC_idle state or a current RRC_inactive state. The configuration to the terrestrial UE 602 of the emergency-Msg-Aircraft-Relaying-PEI and/or an associated paging indication configuration may be received by the terrestrial UE 602 when an aircraft that supports a message relay service is flying within the range of the terrestrial UE 602.

The relay node 606 located at the aircraft may similarly receive, at 609, system information from a last base station or a last satellite/NTN device 608 to which the relay node 606 was RRC_connected. For example, the relay node 606 may receive, at 609, system information indicative of PEIs, paging indications, pre-configuration sets, etc. A CSS or a DSS for an emergency-Msg-Aircraft-Relaying-PEI may be configured to the relay node 606 by the last base station or the last satellite/NTN device 608 to which the relay node 606 was RRC_connected through RRC signaling or a MAC-CE. The configuration to the relay node 606 of the emergency-Msg-Aircraft-Relaying-PEI and/or an associated paging indication configuration may be received by the relay node 606 when the aircraft that supports the message relay service is flying within the range of the terrestrial UE 602. In further examples, rather than the system information being received, at 609, by the relay node 606 and received, at 614, by the terrestrial UE 602 from other network entities, the relay node 606 and the terrestrial UE 602 may be pre-configured, at 604, based on standardized protocols.

The relay node 606 located at the aircraft that supports the message relay service (e.g., emergency message relay service) between the terrestrial UE 602 and a base station may indicate, at 610, to the NTN device 608 that the relay node 606 supports the message relay service. The relay node 606 may transmit the indication, at 610, directly to the NTN device 608 or indirectly to the NTN device 608 via a base station. Both the relay node 606 located at the aircraft and the terrestrial UE 602 may monitor for the PEI based on the aircraft supporting the message relay service. For example, if the terrestrial UE 602 has a message (e.g., emergency message) to transmit to the base station while the terrestrial UE 602 is outside a coverage area of the base station, the terrestrial UE 602 may monitor, at 616, for the emergency-Msg-Aircraft-Relaying-PEI. The terrestrial UE 602 may monitor, at 616, for the PEI in the CSS or the DSS configured to the terrestrial UE 602 by the last base station or the last satellite/NTN device 608 with which the terrestrial UE 602 was in the RRC_connected state. The monitoring, at 616, may be based on a determination at the terrestrial UE 602 to transmit a relayed message to the base station, such that the terrestrial UE 602 may conserve battery power consumed by monitoring for PEIs at times when the terrestrial UE 602 does not have a relayed message to transmit to the base station.

Based on the indication received, at 610, from the relay node 606, the NTN device 608 may indicate, at 618, a PEI for the terrestrial UE 602 to both the terrestrial UE 602 and the relay node 606 for areas that are covered by the aircraft/relay node 606. The PEI may be indicative of a preamble format, a dedicated RNTI, and/or a resource set. The PEI may be received, at 620a, by the relay node 606 and received, at 620b, by the terrestrial UE 602. In examples, the relay node 606 may indicate a location of the aircraft to the NTN device 608 for PEI transmission to the relay node 606 and the terrestrial UE 602.

In the example illustrated by the diagram 600, both the PEI and the paging indication are transmitted by the NTN device 608. The paging indication for the relay node 606 and the terrestrial UE 602 may be transmitted, at 622, to the relay node 606 and the terrestrial UE 602 following PEI reception, at 620a-620b, by the relay node 606 and the terrestrial UE 602. The paging indication may be indicative of an index of the pre-configuration sets for aircraft-based UE access by the terrestrial UE 602. The index may correspond to a preamble format index, a dedicated RNTI index, and/or a resource set index, which may be used for emergency message transmissions/relays. The paging indication may be received, at 624a, by the relay node 606 and received, at 624b, by the terrestrial UE 602 from the NTN device 608. Pre-configuration and indexing techniques may be used for paging indications with decreased payload sizes.

The relay node 606 may initiate, at 626, a monitoring window for a message transmission from the terrestrial UE 602 based on transmission, at 618, of the PEI and transmission, at 622, of the paging indication to the relay node 606 and the terrestrial UE 602. Aircrafts within a range of each other may utilize different preamble formats, different RNTIs, different resource sets, etc., to avoid ATG communication collisions. At 628, the terrestrial UE 602 may transmit the message (e.g., emergency message) to the relay node 606 located at the aircraft based on the configurations transmitted, at 622, by the NTN device 608 via the paging indication. The relay node 606 may relay the message transmission from the terrestrial UE 602 to the base station.

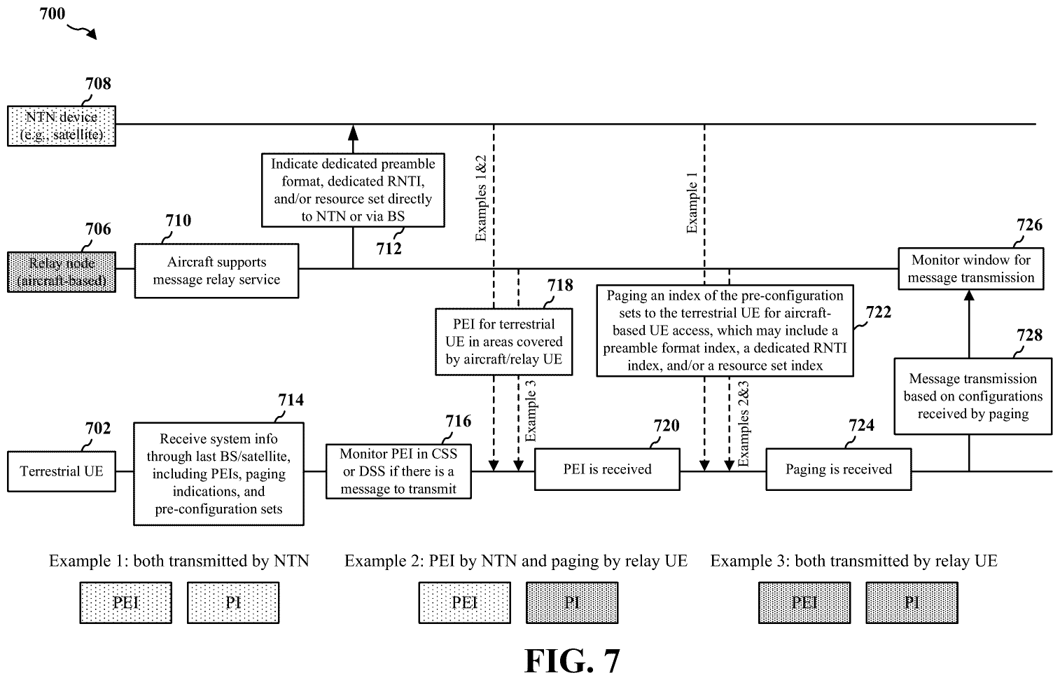

FIG. 7 is a flow diagram 700 illustrating communications between a terrestrial UE 702, a relay node 706 (e.g., aircraft-based UE), and an NTN device 708 (e.g., satellite) for paging-assisted message delivery. The relay node 706 located at the aircraft may determine, at 710, that the aircraft supports a message relay service (e.g., emergency message relay service) for relaying messages between the terrestrial UE 702 and a base station. The relay node 706 may be pre-configured based on standardized protocols. Accordingly, the relay node 706 may indicate, at 712, a dedicated preamble format, a dedicated RNTI, and/or a resource set directly to the NTN device 708 or indirectly to the NTN device 708 via a base station. Based on the indication received, at 712, from the relay node 706, the NTN device 708 may transmit PEIs and/or paging indications to the terrestrial UE 702 based on the aircraft flying within a range of the terrestrial UE 702.

The terrestrial UE 702 may receive, at 714, system information from a last base station or a last satellite/NTN device 708 with which the terrestrial UE 702 was in an RRC_connected state. For example, the terrestrial UE 702 may receive, at 714, system information indicative of PEIs, paging indications, pre-configuration sets, etc. A CSS or a DSS for an emergency-Msg-Aircraft-Relaying-PEI may be configured to the terrestrial UE 702 through RRC signaling or a MAC-CE prior to the terrestrial UE 702 switching from the RRC_connected state to a current RRC_idle state or a current RRC_inactive state. The configuration to the terrestrial UE 702 of the emergency-Msg-Aircraft-Relaying-PEI and/or an associated paging indication configuration may be received by the terrestrial UE 702 when the aircraft that supports the message relay service is flying within the range of the terrestrial UE 702.

If the terrestrial UE 702 has a message (e.g., emergency message) to transmit to the base station while the terrestrial UE 702 is outside a coverage area of the base station, the terrestrial UE 702 may monitor, at 716, for the emergency-Msg-Aircraft-Relaying-PEI. The terrestrial UE 702 may monitor, at 716, for the PEI in the CSS or the DSS configured to the terrestrial UE 702 by the last base station or the last satellite/NTN device 708 with which the terrestrial UE 702 was in the RRC_connected state. The monitoring, at 716, may be based on a determination at the terrestrial UE 702 to transmit a relayed message to the base station, such that the terrestrial UE 702 may conserve battery power consumed by monitoring for PEIs at times when the terrestrial UE 702 does not have a relayed message to transmit to the base station.

The terrestrial UE 702 may receive the PEI, at 720, and the paging indication, at 724, based on different PEI/paging transmission techniques. In a first example, both the PEI and the paging indication may be transmitted from the NTN device 708 to the terrestrial UE 702. In a second example, the PEI may be transmitted from the NTN device 708 to the terrestrial UE 702 and the paging indication may be transmitted from the relay node 706 to the terrestrial UE 702. In a third example, both the PEI and the paging indication may be transmitted from the relay node 706 to the terrestrial UE 702.

The PEI for the terrestrial UE 702 may be transmitted, at 718, in areas that are covered by the aircraft/relay node 706. If the PEI is transmitted, at 718, by the NTN device 708, the relay node 706 may indicate a location of the aircraft to the NTN device 708 for PEI transmission to the terrestrial UE 702. The PEI may be received, at 720, by the terrestrial UE 702 from either the relay node 706 or the NTN device 708. The paging indication for the terrestrial UE 702 may be transmitted, at 722, to the terrestrial UE 702 following transmission/reception of the PEI, at 718-720. The paging indication transmitted, at 722, to the terrestrial UE 702 may be indicative of an index of the pre-configuration sets for aircraft-based UE access by the terrestrial UE 702. The index may correspond to a preamble format index, a dedicated RNTI index, and/or a resource set index, which may be used for emergency message transmissions. The paging indication may be received, at 724, by the terrestrial UE 702 from either the relay node 706 or the NTN device 708. Pre-configuration and indexing techniques may be used for paging indications with decreased payload sizes.

The relay node 706 may initiate, at 726, a monitoring window for a message transmission from the terrestrial UE 702 based on transmission, at 718, of the PEI and transmission, at 722, of the paging indication. Aircrafts within a range of each other may utilize different preamble formats, different RNTIs, different resource sets, etc., to avoid ATG communication collisions. At 728, the terrestrial UE 702 may transmit the message (e.g., emergency message) to the relay node 706 located at the aircraft based on the configurations received, at 722, via the paging indication. The relay node 706 may relay the message transmission from the terrestrial UE 702 to the base station.

Accordingly, aircraft-based UEs included at aircrafts that support message relaying services may indicate fixed/dedicated configurations to the satellite/NTN device 708. The terrestrial UE 702 may receive a configuration for an emergency-Msg-Aircraft-Relaying-PEI and/or an associated paging indication to transmit an emergency message to the aircraft-based UE based on the message relaying service. Aircrafts with different capabilities and/or different trajectories may indicate dedicated configurations for the message relaying service. The dedicated configurations may be based on an aircraft company, an aircraft type/model, an aircraft altitude, a flying direction of the aircraft, a footprint country, etc. Some preamble format pre-configurations, dedicated RNTI pre-configurations, resource set pre-configurations, and/or other pre-configurations may correspond to a default configuration. For example, in the emergency-Msg-Aircraft-Relaying-PEI, the terrestrial UE 702 and/or the relay node 706 located at the aircraft may receive an indication to use a default configuration for message transmission/reception. In such cases, the terrestrial UE 702 and/or the relay node 706 may skip/refrain from performing paging PDCCH monitoring.

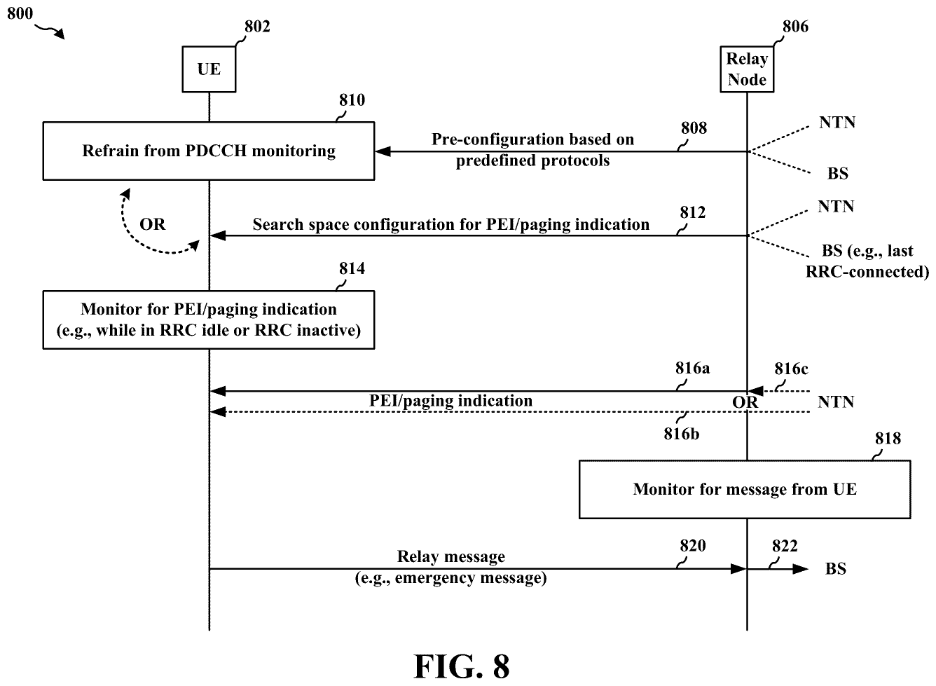

FIG. 8 is a call flow diagram 800 illustrating communications between a UE 802 and a relay node 806 (e.g., a base station, an IAB node, a relay UE, etc.). At 808, the UE 802 and the relay node 806 may receive a pre-configuration based on predefined protocols. For example, the predefined protocols may correspond to one or more standardized rules. The pre-configuration may be transmitted from an NTN or a base station, such as a base station, and may be indicative of PEIs, paging indications, pre-configuration sets, etc., for delivery of a message (e.g., emergency message) from a terrestrial UE to the base station via an aircraft-based relay node. The aircraft-based relay node may be in communication with the terrestrial UE and the base station. At 810, the UE 802 may refrain from monitoring for paging indications based on a default configuration for message transmission/reception.

At 812, the UE 802 may receive a search space configuration for a PEI/paging indication. A search space may refer to a set of resources that the UE 802 is configured to scan for receiving the PEI/paging indication. In examples, the search space configuration may correspond to a CSS or a DSS. The search space configuration may be received from the relay node 806, an NTN, and/or a base station (e.g., a last RRC-connected base station to the UE 802). At 814, the UE 802 may monitor for the PEI/paging indication based on the search space configuration received, at 812. For example, the UE 802 may monitor for the PEI/paging indication, at 814, while the UE 802 is in an RRC idle state or an RRC inactive state and while the UE 802 is outside a coverage area of a terrestrial base station.

The UE 802 may receive, at 816a/816b, the PEI/paging indication. In a first example, the PEI/paging indication may be received, at 816a, by the UE 802 from the relay node 806. In a second example, the PEI/paging indication may be received, at 816b, by the UE 802 from the NTN. In a third example, where the PEI/paging indication is received, at 816b, by the UE 802 from the NTN, the relay node 806 may likewise receive, at 816c, the PEI/paging indication from the NTN.

At 818, the relay node 806 may monitor for a message from the UE 802 based on the PEI/paging indication. At 820, the UE 802 may transmit a relay message to the relay node 806. For example, the relay message may correspond to an emergency message from the UE 802 to be relayed by the relay node 806 to a base station. At 822, the relay node 806 may relay the message received, at 820, from the first UE 802 to the base station. For example, the relay node 806 may be an aircraft-based relay node that receives, at 820, the message from a terrestrial UE and relays the message from the terrestrial UE, at 822, to a base station.

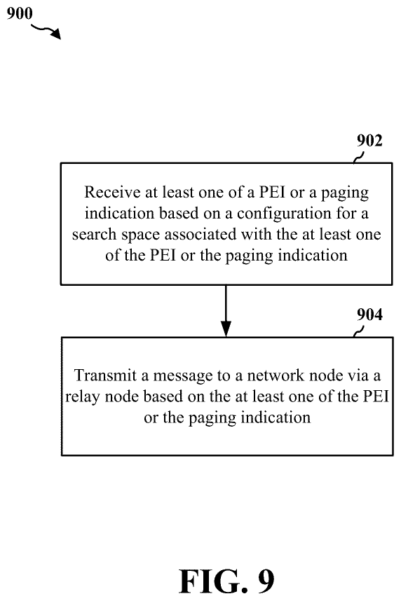

FIG. 9 is a flowchart 900 of a method of wireless communication. The method may be performed by a UE (e.g., the UE 104, 350, 402, 502, 602, 702, 802, the apparatus 1504, etc.), which may include the memory 360 and which may correspond to the entire UE 104, 350, 402, 502, 602, 702, 802 or apparatus 1504, or a component of the UE 104, 350, 402, 502, 602, 702, 802 or the apparatus 1504, such as the TX processor 368, the RX processor 356, the controller/processor 359, the cellular baseband processor 1524, and/or the application processor 1506.

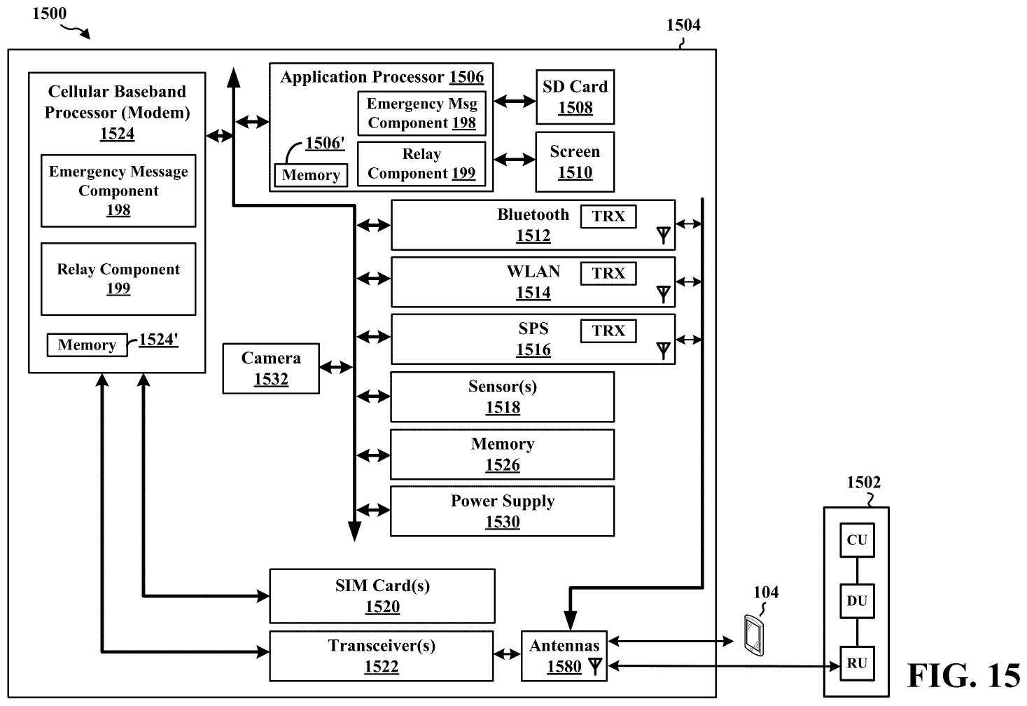

At 902, the UE may receive at least one of a PEI or a paging indication based on a configuration for a search space associated with the at least one of the PEI or the paging indication. For example, referring to FIGS. 4-8, the UE 802 may receive, at 816a-816b, the PEI/paging indication from the relay node 806 or the NTN based on the search space configuration received, at 812, for the PEI/paging indication. In the diagram 400, the terrestrial UE 402 may receive the PEI or the paging indication from the NTN device 408 (e.g., satellite) or from an aircraft-based UE located at the aircraft 406. In the diagrams 500-700, the terrestrial UE 502/602/702 may receive, at 518-520/618/620b/718-720, the PEI in areas covered by the aircraft/relay node 506/606/706 and may receive, at 522-524/622/624b/722-724, the paging indication for an index of the pre-configuration, based on the system information received, at 514/614/714, or the pre-configuration received, at 604, based on the standardized protocols. The reception, at 902, may be performed by the emergency message component 198 of the apparatus 1504 in FIG. 15.

At 904, the UE may transmit a message to a network node via a relay node based on the at least one of the PEI or the paging indication. For example, referring to FIGS. 4-8, the UE 802 may transmit, at 820, the relay message (e.g., emergency message) to a base station via the relay node 806 based on the PEI/paging indication received, at 816a-816b. In the diagram 400, message delivery of a message transmitted from the terrestrial UE 402 to the aircraft 406 may be based on the PEI and the paging indication received by the terrestrial UE 402, where the message may be relayed from the aircraft 406 to a base station 404. In the diagrams 500-700, the terrestrial UE 502/602/702 may transmit, at 528/628/728, a message transmission to the relay node 506/606/706 based on the configurations received in association with the paging indication. The transmission, at 904, may be performed by the emergency message component 198 of the apparatus 1504 in FIG. 15.

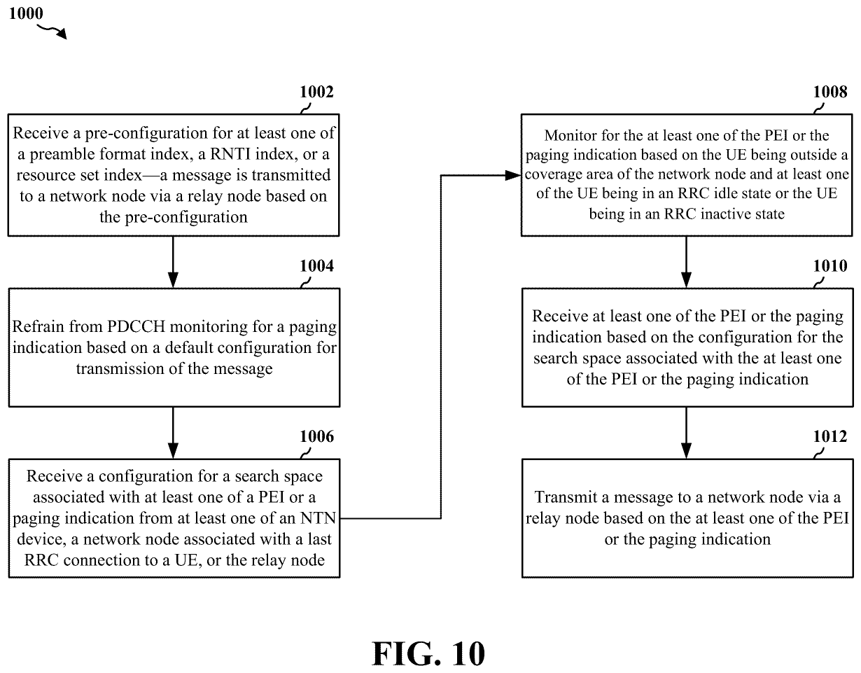

FIG. 10 is a flowchart 1000 of a method of wireless communication. The method may be performed by a UE (e.g., the UE 104, 350, 402, 502, 602, 702, 802, the apparatus 1504, etc.), which may include the memory 360 and which may correspond to the entire UE 104, 350, 402, 502, 602, 702, 802 or apparatus 1504, or a component of the UE 104, 350, 402, 502, 602, 702, 802 or the apparatus 1504, such as the TX processor 368, the RX processor 356, the controller/processor 359, the cellular baseband processor 1524, and/or the application processor 1506.

At 1002, the UE may receive a pre-configuration for at least one of a preamble format index, a RNTI index, or a resource set index-a message is transmitted to a network node via a relay node based on the pre-configuration. For example, referring to FIGS. 6 and 8, the UE 802 may receive, at 808, a pre-configuration from the relay node 806 based on predefined protocols, where the UE 802 may transmit, at 820, a relay message (e.g., emergency message) to the relay node 806 based on the pre-configuration received, at 808. In the diagram 600, the terrestrial UE 602 may receive, at 604, a pre-configuration based on standardized protocols. The reception, at 1002, may be performed by the emergency message component 198 of the apparatus 1504 in FIG. 15.

At 1004, the UE may refrain from PDCCH monitoring for a paging indication based on a default configuration for transmission of the message. For example, referring to FIG. 8, the UE 802 may refrain, at 810, from PDCCH monitoring based on the pre-configuration received, at 808, from the relay node 806. The refraining, at 1004, may be performed by the emergency message component 198 of the apparatus 1504 in FIG. 15.

At 1006, the UE may receive a configuration for a search space associated with at least one of a PEI or a paging indication from at least one of an NTN device, a network node associated with a last RRC connection to a UE, or the relay node. The last RRC connection may correspond to a most recent RRC connected state of the UE prior to the UE switching to a current state of RRC idle or RRC inactive. For example, referring to FIGS. 5-8, the UE 802 may receive, at 812, a search space configuration for a PEI/paging indication from the relay node 806, an NTN, or a base station (e.g., a last RRC-connected base station). In the diagrams 500-700, the terrestrial UE 502/602/702 may receive, at 514/614/714, system information from a last base station or a satellite, including PEIs, paging indications, and pre-configuration sets. The reception, at 1006, may be performed by the emergency message component 198 of the apparatus 1504 in FIG. 15.

At 1008, the UE may monitor for the at least one of the PEI or the paging indication based on the UE being outside a coverage area of the network node and at least one of the UE being in an RRC idle state or the UE being in an RRC inactive state. For example, referring to FIGS. 5-8, the UE 802 may monitor, at 814, for the PEI/paging indication (e.g., while in RRC idle or RRC inactive). In the diagrams 500-700, the terrestrial UE 502/602/702 may monitor, at 516/616/716, for PEI in a CSS or a DSS, if the terrestrial UE 502/602/702 has a message to transmit. The monitoring, at 1008, may be performed by the emergency message component 198 of the apparatus 1504 in FIG. 15.

At 1010, the UE may receive at least one of the PEI or the paging indication based on the configuration for the search space associated with the at least one of the PEI or the paging indication. For example, referring to FIGS. 4-8, the UE 802 may receive, at 816a-816b, the PEI/paging indication from the relay node 806 or the NTN based on the search space configuration received, at 812, for the PEI/paging indication. In the diagram 400, the terrestrial UE 402 may receive the PEI or the paging indication from the NTN device 408 (e.g., satellite) or from an aircraft-based UE located at the aircraft 406. In the diagrams 500-700, the terrestrial UE 502/602/702 may receive, at 518-520/618/620b/718-720, the PEI in areas covered by the aircraft/relay node 506/606/706 and may receive, at 522-524/622/624b/722-724, the paging indication for an index of the pre-configuration, based on the system information received, at 514/614/714, or the pre-configuration received, at 604, based on the standardized protocols. The reception, at 1010, may be performed by the emergency message component 198 of the apparatus 1504 in FIG. 15.

At 1012, the UE may transmit a message to a network node via a relay node based on the at least one of the PEI or the paging indication. For example, referring to FIGS. 4-8, the UE 802 may transmit, at 820, the relay message (e.g., emergency message) to a base station via the relay node 806 based on the PEI/paging indication received, at 816a-816b. In the diagram 400, message delivery of a message transmitted from the terrestrial UE 402 to the aircraft 406 may be based on the PEI and the paging indication received by the terrestrial UE 402, where the message may be relayed from the aircraft 406 to a base station 404. In the diagrams 500-700, the terrestrial UE 502/602/702 may transmit, at 528/628/728, a message transmission to the relay node 506/606/706 based on the configurations received in association with the paging indication. The transmission, at 1012, may be performed by the emergency message component 198 of the apparatus 1504 in FIG. 15.

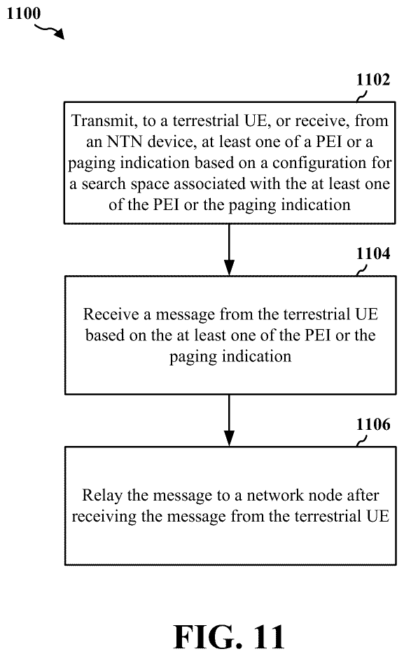

FIG. 11 is a flowchart 1100 of a method of wireless communication. The method may be performed by a relay node (e.g., the UE 104, relay node 310, 506, 606, 706, 806, the aircraft 406, the apparatus 1504, etc.), which may include the memory 376 and which may correspond to the entire UE 104, relay node 310, 506, 606, 706, 806 or apparatus 1504, or a component of the UE 104, relay node 310, 506, 606, 706, 806 or the apparatus 1504, such as the TX processor 316, the RX processor 370, and/or the controller/processor 375.

At 1102, the relay node may transmit, to a terrestrial UE, or receive, from an NTN device, at least one of a PEI or a paging indication based on a configuration for a search space associated with the at least one of the PEI or the paging indication. For example, referring to FIGS. 5-8, the relay node 806 may transmit, at 816a, the PEI/paging indication to the UE 802 or receive, at 816c, the PEI/paging indication from the NTN. In the diagrams 500/700, the relay node 506/706 may transmit, at 518/718, the PEI for the terrestrial UE 502/702 in areas covered by the aircraft/relay node 506/706 and may transmit, at 522/722, the paging indication in association with the configuration to the terrestrial UE 502/702. In the diagram 600, the relay node 606 may receive, at 618, the PEI for the terrestrial UE 602 in areas covered by the aircraft/relay node 606 and may receive, at 622, the paging indication in association with the configuration from the NTN device 608. The transmission or reception, at 1102, may be performed by the relay component 199 of the apparatus 1504 in FIG. 15.

At 1104, the relay node may receive a message from the terrestrial UE based on the at least one of the PEI or the paging indication. For example, referring to FIGS. 4-8, the relay node 806 may receive, at 820, a relay message (e.g., emergency message) from the UE 802 based on the PEI/paging indication. In the diagram 400, an aircraft-based UE located at the aircraft 406 may receive a message delivery from the terrestrial UE 402 based on the PEI and the paging indication. In the diagrams 500-700, the relay node 506/606/706 may receive, at 528/628/728, a message transmission from the terrestrial UE 502/602/702 based on the configurations associated with the paging indication. The reception, at 1104, may be performed by the relay component 199 of the apparatus 1504 in FIG. 15.

At 1106, the relay node may relay the message to a network node after receiving the message from the terrestrial UE. For example, referring to FIGS. 4 and 8, the relay node 806 may transmit, at 822, the relay message (e.g., emergency message) to a base station after receiving, at 820, the relay message (e.g., emergency message) from the UE 802. In the diagram 400, the aircraft-based UE located at the aircraft 406 may relay the message received from the terrestrial UE 402 to the base station 404 after receiving the message from the terrestrial UE 402 based on the PEI and the paging information. The relaying, at 1106, may be performed by the relay component 199 of the apparatus 1504 in FIG. 15.

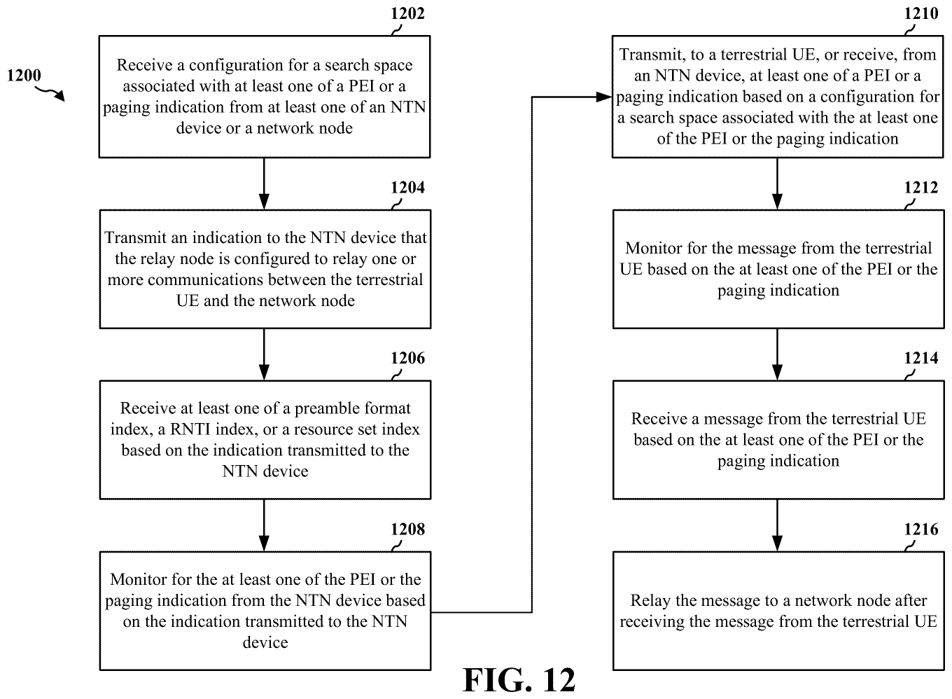

FIG. 12 is a flowchart 1200 of a method of wireless communication. The method may be performed by a relay node (e.g., the UE 104, relay node 310, 506, 606, 706, 806, the aircraft 406, the apparatus 1504, etc.), which may include the memory 376 and which may correspond to the entire UE 104, relay node 310, 506, 606, 706, 806 or apparatus 1504, or a component of the UE 104, relay node 310, 506, 606, 706, 806 or the apparatus 1504, such as the TX processor 316, the RX processor 370, and/or the controller/processor 375.

At 1202, the relay node may receive a configuration for a search space associated with at least one of a PEI or a paging indication from at least one of an NTN device or a network node. For example, referring to FIGS. 5-6 and 8, the relay node 806 may receive, at 812, a search space configuration for a PEI/paging indication from an NTN or a base station. In the diagram 500, the relay node 506 may receive, at 512, an indication of a preamble format, a dedicated RNTI, and/or a resource set from the NTN device 508. In the diagram 600, the relay node 606 may receive system information, at 609, from a base station or a satellite, including PEIs, paging indications, and pre-configuration sets. The reception, at 1202, may be performed by the relay component 199 of the apparatus 1504 in FIG. 15.

At 1204, the relay node may transmit an indication to the NTN device that the relay node is configured to relay one or more communications between the terrestrial UE and the network node. For example, referring to FIGS. 5-7, the relay node 506/606 may transmit, at 510/610, an indication directly to the NTN device 508/608 or through a base station that the relay node 506/606 located at the aircraft supports a message relay service. In the diagram 700, the relay node 706 may indicate, at 712, a dedicated preamble format, a dedicated RNTI, and/or a resource set directly to the NTN device 708 or via a base station, which may be based on the configuration, at 710, that the relay node 706 located at the aircraft supports the message relay service. The transmission, at 1204, may be performed by the relay component 199 of the apparatus 1504 in FIG. 15.

At 1206, the relay node may receive at least one of a preamble format index, a RNTI index, or a resource set index based on the indication transmitted to the NTN device. For example, referring to FIGS. 5-6, the relay node 506/606 may receive, at 512/622, an indication of a preamble format, a dedicated RNTI, and/or a resource set from the NTN device 508/608 based on the indication transmitted, at 510/610, from the relay node 506/606 to the NTN device 508/608. The reception, at 1206, may be performed by the relay component 199 of the apparatus 1504 in FIG. 15.

At 1208, the relay node may monitor for the at least one of the PEI or the paging indication from the NTN device based on the indication transmitted to the NTN device. For example, referring to FIGS. 6 and 8, the relay node 806 may monitor, at 816c, for the PEI/paging indication from the NTN. In the diagram 600, the relay node 606 may monitor, at 618, for the PEI from the NTN device 608 and may monitor, at 622, for the paging indication from the NTN device 608. The monitoring, at 1208, may be performed by the relay component 199 of the apparatus 1504 in FIG. 15.

At 1210, the relay node may transmit, to a terrestrial UE, or receive, from an NTN device, at least one of a PEI or a paging indication based on a configuration for a search space associated with the at least one of the PEI or the paging indication. For example, referring to FIGS. 5-8, the relay node 806 may transmit, at 816a, the PEI/paging indication to the UE 802 or receive, at 816c, the PEI/paging indication from the NTN. In the diagrams 500/700, the relay node 506/706 may transmit, at 518/718, the PEI for the terrestrial UE 502/702 in areas covered by the aircraft/relay node 506/706 and may transmit, at 522/722, the paging indication in association with the configuration to the terrestrial UE 502/702. In the diagram 600, the relay node 606 may receive, at 618, the PEI for the terrestrial UE 602 in areas covered by the aircraft/relay node 606 and may receive, at 622, the paging indication in association with the configuration from the NTN device 608. The transmission or reception, at 1210, may be performed by the relay component 199 of the apparatus 1504 in FIG. 15.

At 1212, the relay node may monitor for the message from the terrestrial UE based on the at least one of the PEI or the paging indication. For example, referring to FIGS. 5-8, the relay node 806 may monitor, at 818, for a message from the UE 802 based on the PEI/paging indication. In the diagrams 500-700, the relay node 506/606/706 may monitor, at 526/626/726, for a message transmission from the terrestrial UE 502/602/702 during a monitor window for the message transmission. The monitoring, at 1212, may be performed by the relay component 199 of the apparatus 1504 in FIG. 15.

At 1214, the relay node may receive a message from the terrestrial UE based on the at least one of the PEI or the paging indication. For example, referring to FIGS. 4-8, the relay node 806 may receive, at 820, a relay message (e.g., emergency message) from the UE 802 based on the PEI/paging indication. In the diagram 400, an aircraft-based UE located at the aircraft 406 may receive a message delivery from the terrestrial UE 402 based on the PEI and the paging indication. In the diagrams 500-700, the relay node 506/606/706 may receive, at 528/628/728, a message transmission from the terrestrial UE 502/602/702 based on the configurations associated with the paging indication. The reception, at 1214, may be performed by the relay component 199 of the apparatus 1504 in FIG. 15.

At 1216, the relay node may relay the message to a network node after receiving the message from the terrestrial UE. For example, referring to FIGS. 4 and 8, the relay node 806 may transmit, at 822, the relay message (e.g., emergency message) to a base station after receiving, at 820, the relay message (e.g., emergency message) from the UE 802. In the diagram 400, the aircraft-based UE located at the aircraft 406 may relay the message received from the terrestrial UE 402 to the base station 404 after receiving the message from the terrestrial UE 402 based on the PEI and the paging information. The relaying, at 1216, may be performed by the relay component 199 of the apparatus 1504 in FIG. 15.

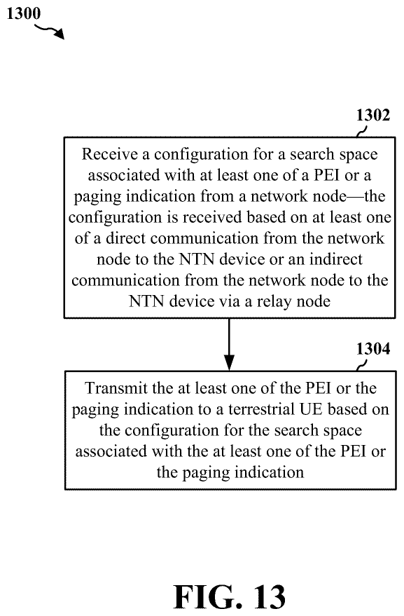

FIG. 13 is a flowchart 1300 of a method of wireless communication. The method may be performed by a network node or a base station (e.g., the network entity 1502, 1602, the base station 102, the CU 110/1610, the DU 130/1630, the RU 140/1640, the SPS 170, etc.), which may correspond to the entire network entity 1502, 1602, SPS 170, or base station 102, or a component of the network entity 1502, 1602, the SPS 170, or the base station 102, such as the CU 110/1610, the DU 130/1630, the RU 140/1640.

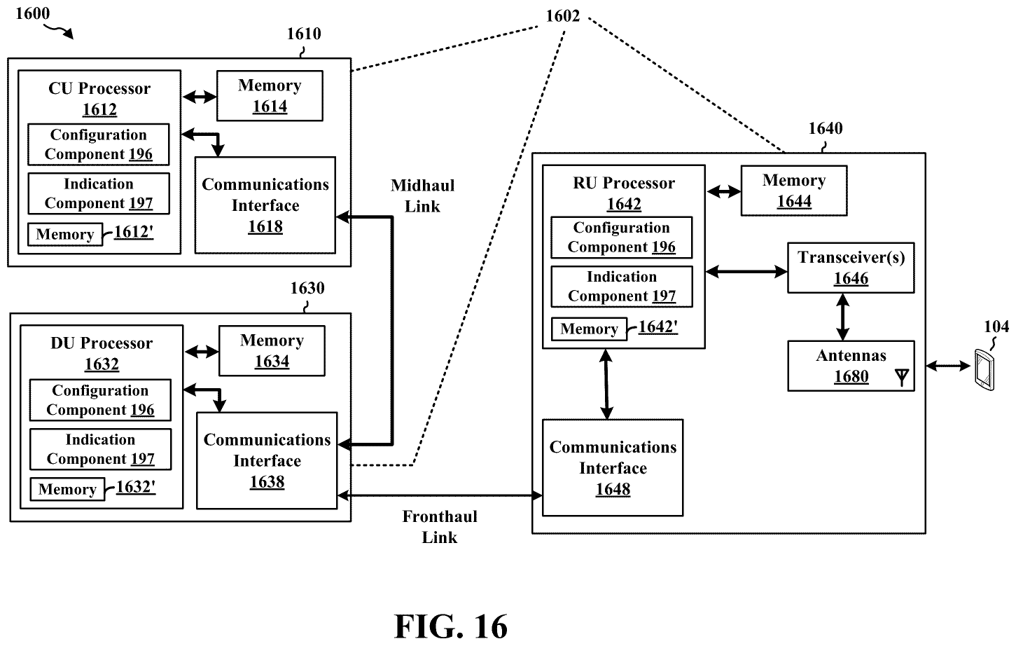

At 1302, the network node or the base station (e.g., SPS) may receive a configuration for a search space associated with at least one of a PEI or a paging indication from a network node—the configuration is received based on at least one of a direct communication from the network node to the NTN device or an indirect communication from the network node to the NTN device via a relay node. For example, referring to FIG. 1, the SPS 170 may receive, from the base station 102, a configuration for a search space associated with a PEI/paging indication based on the configuration component 196. The configuration may be transmitted directly from the base station 102 to the SPS 170 or the configuration may be transmitted indirectly from the base station 102 to the SPS 170 via a relay node. The reception, at 1302, may be performed by the indication component 197 of the network entity 1602 in FIG. 16.

At 1304, the network node or the base station (e.g., SPS) may transmit the at least one of the PEI or the paging indication to a terrestrial UE based on the configuration for the search space associated with the at least one of the PEI or the paging indication. For example, referring to FIGS. 1 and 4, the NTN device 408 (e.g., satellite) may transmit the PEI and/or the paging indication to the terrestrial UE 402 (e.g., based on the configuration for the search space associated with the PEI/paging indicated to the SPS 170 via the configuration component 196 of the base station 102). The transmission, at 1304, may be performed by the indication component 197 of the network entity 1602 in FIG. 16.

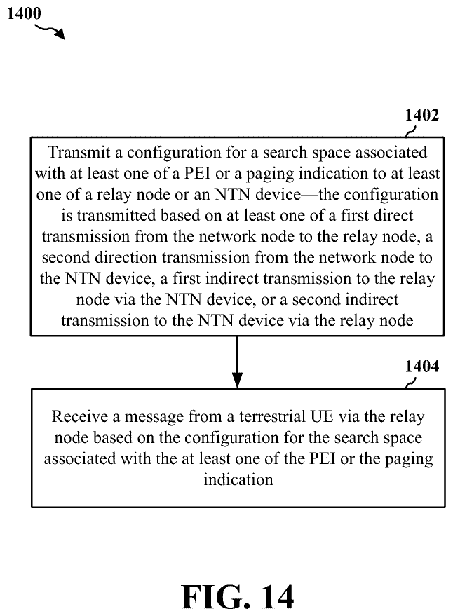

FIG. 14 is a flowchart 1400 of a method of wireless communication. The method may be performed by a network node or a base station (e.g., the network entity 1502, 1602, the base station 102, the CU 110/1610, the DU 130/1630, the RU 140/1640, the SPS 170, etc.), which may correspond to the entire network entity 1502, 1602 or base station 102, or a component of the network entity 1502, 1602 or the base station 102, such as the CU 110/1610, the DU 130/1630, the RU 140/1640.

At 1402, the network node or the base station may transmit a configuration for a search space associated with at least one of a PEI or a paging indication to at least one of a relay node or an NTN device—the configuration is transmitted based on at least one of a first direct transmission from the network node to the relay node, a second direction transmission from the network node to the NTN device, a first indirect transmission to the relay node via the NTN device, or a second indirect transmission to the NTN device via the relay node. For example, referring to FIG. 1, the base station 102 may transmit, to a relay node or the SPS 170, a configuration for a search space associated with a PEI/paging indication based on the configuration component 196. The configuration may be transmitted directly from the base station 102 to the SPS 170 or directly from the base station 102 to the UE 104. In further examples, the configuration may be transmitted indirectly from the base station 102 to the SPS 170 via the UE 104 or indirectly from the base station 102 to the UE 104 via the SPS 170. The transmission, at 1402, may be performed by the configuration component 196 of the network entity 1602 in FIG. 16.

At 1404, the network node or the base station may receive a message from a terrestrial UE via the relay node based on the configuration for the search space associated with the at least one of the PEI or the paging indication. For example, referring to FIGS. 1 and 4, the base station 404 may receive a relayed message from the terrestrial UE 402 via the aircraft-based UE located at the aircraft 406 (e.g., based on the configuration for the search space associated with the PEI/paging indicated via the configuration component 196 of the base station 102). The reception, at 1404, may be performed by the configuration component 196 of the network entity 1602 in FIG. 16.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional modules of memory 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The additional modules of memory 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the UE 350 and may include the memory 360 and/or at least one of the TX processor 368, the RX processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., see 350 of FIG. 3) and include the additional modules of the apparatus 1504.

As discussed supra, the emergency message component 198 is configured to receive at least one of a PEI or a paging indication based on a configuration for a search space associated with the at least one of the PEI or the paging indication; and transmit a message to a network node via a relay node based on the at least one of the PEI or the paging indication; and the relay component 199 is configured to transmit, to a terrestrial UE, or receive, from an NTN device, at least one of a PEI or a paging indication based on a configuration for a search space associated with the at least one of the PEI or the paging indication; receive a message from the terrestrial UE based on the at least one of the PEI or the paging indication; and relay the message to a network node after receiving the message from the terrestrial UE. The emergency message component 198 and/or the relay component 199 may be within the cellular baseband processor 1524, the application processor 1506, or both the cellular baseband processor 1524 and the application processor 1506. The emergency message component 198 and/or the relay component 199 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1504 may include a variety of components configured for various functions. In one configuration, the apparatus 1504, and in particular the cellular baseband processor 1524 and/or the application processor 1506, includes means for receiving at least one of a PEI or a paging indication based on a configuration for a search space associated with the at least one of the PEI or the paging indication; and means for transmitting a message to a network node via a relay node based on the at least one of the PEI or the paging indication. The apparatus 1504 further includes means for receiving the configuration for the search space associated with the at least one of the PEI or the paging indication from at least one of an NTN device, the network node associated with a last RRC connection to the UE, or the relay node. The apparatus 1504 further includes means for monitoring for the at least one of the PEI or the paging indication based on the UE being outside a coverage area of the network node and at least one of the UE being in an RRC idle state or the UE being in an RRC inactive state, where the at least one processor monitors for the at least one of the PEI or the paging indication prior to receiving the at least one of the PEI or the paging indication. The apparatus 1504 further includes means for receiving a pre-configuration for at least one of a preamble format index, a RNTI index, or a resource set index, where the message is transmitted to the network node via the relay node based on the pre-configuration. The apparatus 1504 further includes means for refraining from PDCCH monitoring for the paging indication based on a default configuration for transmission of the message.

As shown, the apparatus 1504 may include a variety of components configured for various functions. In another configuration, the apparatus 1504, and in particular the cellular baseband processor 1524 and/or the application processor 1506, includes means for transmitting, to a terrestrial UE, or means for receiving, from an NTN device, at least one of a PEI or a paging indication based on a configuration for a search space associated with the at least one of the PEI or the paging indication; means for receiving a message from the terrestrial UE based on the at least one of the PEI or the paging indication; and means for relaying the message to a network node after receiving the message from the terrestrial UE. The apparatus 1504 further includes means for receiving the configuration for the search space associated with the at least one of the PEI or the paging indication from at least one of the NTN device or the network node. The apparatus 1504 further includes means for transmitting an indication to the NTN device that the relay node is configured to relay one or more communications between the terrestrial UE and the network node, where the indication is transmitted to the NTN device based on at least one of a direct transmission from the relay node to the NTN device or an indirect transmission from the relay node to the NTN device via the network node. The apparatus 1504 further includes means for receiving at least one of a preamble format index, a RNTI index, or a resource set index based on the indication transmitted to the NTN device. The apparatus 1504 further includes means for monitoring for the at least one of the PEI or the paging indication from the NTN device based on the indication transmitted to the NTN device, where the at least one processor monitors for the at least one of the PEI or the paging indication prior to receiving the at least one of the PEI or the paging indication from the NTN device. The apparatus 1504 further includes means for skipping a PDCCH transmission for the paging indication based on a default configuration for reception of the message. The apparatus 1504 further includes means for monitoring for the message from the terrestrial UE based on the at least one of the PEI or the paging indication, where the at least one processor monitors for the message from the terrestrial UE prior to receiving the message from the terrestrial UE.

The means may be the emergency message component 198 and/or the relay component 199 of the apparatus 1504 configured to perform the functions recited by the means. As described supra, the apparatus 1504 may include the TX processor 368/316, the RX processor 356/370, and the controller/processor 359/375. As such, in one configuration, the means may be the TX processor 368, the RX processor 356, and/or the controller/processor 359 configured to perform the functions recited by the means. In another configuration, the means may be the TX processor 316, the RX processor 370, and/or the controller/processor 375 configured to perform the functions recited by the means.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the indication component 197 and/or the configuration component 196, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the indication component 197 is configured to receive a configuration for a search space associated with at least one of a PEI or a paging indication from a network node, the configuration being received based on at least one of a direct communication from the network node to the NTN device or an indirect communication from the network node to the NTN device via a relay node; and transmit the at least one of the PEI or the paging indication to a terrestrial UE based on the configuration for the search space associated with the at least one of the PEI or the paging indication; and the configuration component 196 is configured to transmit, to a terrestrial UE, or receive, from an NTN device, at least one of a PEI or a paging indication based on a configuration for a search space associated with the at least one of the PEI or the paging indication; receive a message from the terrestrial UE based on the at least one of the PEI or the paging indication; and relay the message to a network node after receiving the message from the terrestrial UE. The indication component 197 and/or the configuration component 196 may be within one or more processors of one or more of the CU 1610, DU 1630, and the RU 1640. The indication component 197 and/or the configuration component 196 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 1602 may include a variety of components configured for various functions. In one configuration, the network entity 1602 includes means for receiving a configuration for a search space associated with at least one of a PEI or a paging indication from a network node, the configuration being received based on at least one of a direct communication from the network node to the NTN device or an indirect communication from the network node to the NTN device via a relay node; and means for transmitting the at least one of the PEI or the paging indication to a terrestrial UE based on the configuration for the search space associated with the at least one of the PEI or the paging indication.

The network entity 1602 may include a variety of components configured for various functions. In another configuration, the network entity 1602 includes means for transmitting a configuration for a search space associated with at least one of a PEI or a paging indication to at least one of a relay node or an NTN device, the configuration being transmitted based on at least one of a first direct transmission from the network node to the relay node, a second direction transmission from the network node to the NTN device, a first indirect transmission to the relay node via the NTN device, or a second indirect transmission to the NTN device via the relay node; and means for receiving a message from a terrestrial UE via the relay node based on the configuration for the search space associated with the at least one of the PEI or the paging indication.

The means may be the indication component 197 and/or the configuration component 196 of the network entity 1602 configured to perform the functions recited by the means. As described supra, the network entity 1602 may include the TX processor 368/316, the RX processor 356/370, and the controller/processor 359/375. As such, in one configuration, the means may be the TX processor 316, the RX processor 370, and/or the controller/processor 375 configured to perform the functions recited by the means. In another configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE, including: receiving at least one of a PEI or a paging indication based on a configuration for a search space associated with the at least one of the PEI or the paging indication; and transmitting a message to a network node via a relay node based on the at least one of the PEI or the paging indication.
Aspect 2 may be combined with aspect 1 and further includes receiving the configuration for the search space associated with the at least one of the PEI or the paging indication from at least one of an NTN device, the network node associated with a last RRC connection to the UE, or the relay node.
Aspect 3 may be combined with any of aspects 1-2 and includes that the configuration is received from the network node associated with the last RRC connection to the UE based on at least one of RRC signaling or a MAC-CE.
Aspect 4 may be combined with any of aspects 1-3 and includes that the configuration for the search space associated with the at least one of the PEI or the paging indication is based on a predefined protocol.
Aspect 5 may be combined with any of aspects 1-4 and further includes monitoring for the at least one of the PEI or the paging indication based on the UE being outside a coverage area of the network node and at least one of the UE being in an RRC idle state or the UE being in an RRC inactive state, where the UE monitors for the at least one of the PEI or the paging indication prior to receiving the at least one of the PEI or the paging indication.
Aspect 6 may be combined with any of aspects 1-5 and includes that the UE monitors for the at least one of the PEI or the paging indication in the search space based on a determination to transmit the message to the network node via the relay node.
Aspect 7 may be combined with any of aspects 1-6 and includes that the paging indication is indicative of at least one of a preamble format index, a RNTI index, or a resource set index, where the message is transmitted to the network node via the relay node based on the at least one of the preamble format index, the RNTI index, or the resource set index.
Aspect 8 may be combined with any of aspects 1-7 and includes that the at least one of the preamble format index, the RNTI index, or the resource set index is configured to avoid a resource collision associated with other scheduled communications.
Aspect 9 may be combined with any of aspects 1-8 and further includes receiving a pre-configuration for at least one of a preamble format index, a RNTI index, or a resource set index, where the message is transmitted to the network node via the relay node based on the pre-configuration.
Aspect 10 may be combined with any of aspects 1-9 and further includes refraining from PDCCH monitoring for the paging indication based on a default configuration for transmission of the message.
Aspect 11 may be combined with any of aspects 1-10 and includes that the at least one of the PEI or the paging indication is received from at least one of an NTN device or the relay node based on the relay node being within a threshold range of the UE.
Aspect 12 may be combined with any of aspects 1-11 and includes that the relay node is located at an aircraft, and where the configuration for the search space associated with the at least one of the PEI or the paging indication is based on at least one of an operator of the aircraft, a type of the aircraft, an altitude of the aircraft, a direction of the aircraft, or a footprint region of the aircraft.
Aspect 13 may be combined with any of aspects 1-12 and includes that the search space corresponds to a CSS or a DSS.
Aspect 14 is a method of wireless communication at a relay node, including: transmitting, to a terrestrial UE, or receiving, from an NTN device, at least one of a PEI or a paging indication based on a configuration for a search space associated with the at least one of the PEI or the paging indication; receiving a message from the terrestrial UE based on the at least one of the PEI or the paging indication; and relaying the message to a network node after receiving the message from the terrestrial UE.
Aspect 15 may be combined with aspect 14 and further includes receiving the configuration for the search space associated with the at least one of the PEI or the paging indication from at least one of the NTN device or the network node.
Aspect 16 may be combined with any of aspects 14-15 and includes that the configuration for the search space associated with the at least one of the PEI or the paging indication is based on a predefined protocol.
Aspect 17 may be combined with any of aspects 14-16 and further includes transmitting an indication to the NTN device that the relay node is configured to relay one or more communications between the terrestrial UE and the network node, where the indication is transmitted to the NTN device based on at least one of a direct transmission from the relay node to the NTN device or an indirect transmission from the relay node to the NTN device via the network node.
Aspect 18 may be combined with any of aspects 14-17 and further includes receiving at least one of a preamble format index, a RNTI index, or a resource set index based on the indication transmitted to the NTN device.
Aspect 19 may be combined with any of aspects 14-18 and includes that the indication transmitted to the NTN device is indicative of at least one of a dedicated preamble format, a dedicated RNTI, or a dedicated resource set index.
Aspect 20 may be combined with any of aspects 14-19 and further includes monitoring for the at least one of the PEI or the paging indication from the NTN device based on the indication transmitted to the NTN device, where the relay node monitors for the at least one of the PEI or the paging indication prior to receiving the at least one of the PEI or the paging indication from the NTN device.
Aspect 21 may be combined with any of aspects 14-20 and includes that the paging indication is indicative of at least one of a preamble format index, a RNTI index, or a resource set index, where the message is received from the terrestrial UE based on the at least one of the preamble format index, the RNTI index, or the resource set index.
Aspect 22 may be combined with any of aspects 14-21 and includes that the at least one of the preamble format index, the RNTI index, or the resource set index is configured to avoid a resource collision associated with other scheduled communications.
Aspect 23 may be combined with any of aspects 14-22 and further includes skipping a PDCCH transmission for the paging indication based on a default configuration for reception of the message.
Aspect 24 may be combined with any of aspects 14-23 and further includes monitoring for the message from the terrestrial UE based on the at least one of the PEI or the paging indication, where the relay node monitors for the message from the terrestrial UE prior to receiving the message from the terrestrial UE.
Aspect 25 may be combined with any of aspects 14-24 and includes that the relay node is located at an aircraft, and where the configuration for the search space associated with the at least one of the PEI or the paging indication is based on at least one of an operator of the aircraft, a type of the aircraft, an altitude of the aircraft, a direction of the aircraft, or a footprint region of the aircraft.
Aspect 26 may be combined with any of aspects 14-25 and includes that the search space corresponds to a CSS or a DSS.
Aspect 27 is a method of wireless communication at an NTN device, including: receiving a configuration for a search space associated with at least one of a PEI or a paging indication from a network node, the configuration being received based on at least one of a direct communication from the network node to the NTN device or an indirect communication from the network node to the NTN device via a relay node; and transmitting the at least one of the PEI or the paging indication to a terrestrial UE based on the configuration for the search space associated with the at least one of the PEI or the paging indication.
Aspect 28 is a method of wireless communication at a network node, including: transmitting a configuration for a search space associated with at least one of a PEI or a paging indication to at least one of a relay node or an NTN device, the configuration being transmitted based on at least one of a first direct transmission from the network node to the relay node, a second direction transmission from the network node to the NTN device, a first indirect transmission to the relay node via the NTN device, or a second indirect transmission to the NTN device via the relay node; and receiving a message from a terrestrial UE via the relay node based on the configuration for the search space associated with the at least one of the PEI or the paging indication.
Aspect 29 is an apparatus for wireless communication for implementing a method as in any of aspects 1-28.
Aspect 30 is an apparatus for wireless communication including means for implementing a method as in any of aspects 1-28.
Aspect 31 may be combined with any of aspects 29-30 and further includes at least one of a transceiver or an antenna coupled to at least one processor of the apparatus.
Aspect 32 is a non-transitory computer-readable medium storing computer executable code, the code when executed by at least one processor causes the at least one processor to implement a method as in any of aspects 1-28.

What is claimed is:

1. An apparatus for wireless communication at a user equipment (UE), comprising:
a memory; and
at least one processor coupled to the memory and, based at least in part on information stored in the memory, the at least one processor is configured to:
receive at least one of a paging early indication (PEI) or a paging indication based on a configuration for a search space associated with the at least one of the PEI or the paging indication; and
transmit a message to a network node via a relay node based on the at least one of the PEI or the paging indication.

2. The apparatus of claim 1, wherein the at least one processor is further configured to receive the configuration for the search space associated with the at least one of the PEI or the paging indication from at least one of a non-terrestrial network (NTN) device, the network node associated with a last radio resource control (RRC) connection to the UE, or the relay node.

3. The apparatus of claim 2, wherein the configuration is received from the network node associated with the last RRC connection to the UE based on at least one of RRC signaling or a medium access control (MAC) control element (MAC-CE).

4. The apparatus of claim 1, wherein the configuration for the search space associated with the at least one of the PEI or the paging indication is based on a predefined protocol.

5. The apparatus of claim 1, wherein the at least one processor is further configured to monitor for the at least one of the PEI or the paging indication based on the UE being outside a coverage area of the network node and at least one of the UE being in a radio resource control (RRC) idle state or the UE being in an RRC inactive state, wherein the at least one processor monitors for the at least one of the PEI or the paging indication prior to receiving the at least one of the PEI or the paging indication.

6. The apparatus of claim 5, wherein the at least one processor monitors for the at least one of the PEI or the paging indication in the search space based on a determination to transmit the message to the network node via the relay node.

7. The apparatus of claim 1, wherein the paging indication is indicative of at least one of a preamble format index, a radio network temporary identifier (RNTI) index, or a resource set index, wherein the message is transmitted to the network node via the relay node based on the at least one of the preamble format index, the RNTI index, or the resource set index.

8. The apparatus of claim 7, wherein the at least one of the preamble format index, the RNTI index, or the resource set index is configured to avoid a resource collision associated with other scheduled communications.

9. The apparatus of claim 1, wherein the at least one processor is further configured to receive a pre-configuration for at least one of a preamble format index, a radio network temporary identifier (RNTI) index, or a resource set index, wherein the message is transmitted to the network node via the relay node based on the pre-configuration.

10. The apparatus of claim 9, wherein the at least one processor is further configured to refrain from physical downlink control channel (PDCCH) monitoring for the paging indication based on a default configuration for transmission of the message.

11. The apparatus of claim 1, wherein the at least one of the PEI or the paging indication is received from at least one of a non-terrestrial network (NTN) device or the relay node based on the relay node being within a threshold range of the UE.

12. The apparatus of claim 1, wherein the relay node is located at an aircraft, and wherein the configuration for the search space associated with the at least one of the PEI or the paging indication is based on at least one of an operator of the aircraft, a type of the aircraft, an altitude of the aircraft, a direction of the aircraft, or a footprint region of the aircraft.

13. The apparatus of claim 1, wherein the search space corresponds to a common search space (CSS) or a dedicated search space (DSS).

14. The apparatus of claim 1, further comprising at least one of a transceiver or an antenna coupled to the at least one processor.

15. An apparatus for wireless communication at a relay node, comprising:
a memory; and
at least one processor coupled to the memory and, based at least in part on information stored in the memory, the at least one processor is configured to:
transmit, to a terrestrial user equipment (UE), or receive, from a non-terrestrial network (NTN) device, at least one of a paging early indication (PEI) or a paging indication based on a configuration for a search space associated with the at least one of the PEI or the paging indication;
receive a message from the terrestrial UE based on the at least one of the PEI or the paging indication; and
relay the message to a network node after receiving the message from the terrestrial UE.

16. The apparatus of claim 15, wherein the at least one processor is further configured to receive the configuration for the search space associated with the at least one of the PEI or the paging indication from at least one of the NTN device or the network node.

17. The apparatus of claim 15, wherein the configuration for the search space associated with the at least one of the PEI or the paging indication is based on a predefined protocol.

18. The apparatus of claim 15, wherein the at least one processor is further configured to transmit an indication to the NTN device that the relay node is configured to relay one or more communications between the terrestrial UE and the network node, wherein the indication is transmitted to the NTN device based on at least one of a direct transmission from the relay node to the NTN device or an indirect transmission from the relay node to the NTN device via the network node.

19. The apparatus of claim 18, wherein the at least one processor is further configured to receive at least one of a preamble format index, a radio network temporary identifier (RNTI) index, or a resource set index based on the indication transmitted to the NTN device.

20. The apparatus of claim 18, wherein the indication transmitted to the NTN device is indicative of at least one of a dedicated preamble format, a dedicated radio network temporary identifier (RNTI), or a dedicated resource set index.

21. The apparatus of claim 18, wherein the at least one processor is further configured to monitor for the at least one of the PEI or the paging indication from the NTN device based on the indication transmitted to the NTN device, wherein the at least one processor monitors for the at least one of the PEI or the paging indication prior to receiving the at least one of the PEI or the paging indication from the NTN device.

22. The apparatus of claim 15, wherein the paging indication is indicative of at least one of a preamble format index, a radio network temporary identifier (RNTI) index, or a resource set index, wherein the message is received from the terrestrial UE based on the at least one of the preamble format index, the RNTI index, or the resource set index.

23. The apparatus of claim 22, wherein the at least one of the preamble format index, the RNTI index, or the resource set index is configured to avoid a resource collision associated with other scheduled communications.

24. The apparatus of claim 22, wherein the at least one processor is further configured to skip a physical downlink control channel (PDCCH) transmission for the paging indication based on a default configuration for reception of the message.

25. The apparatus of claim 15, wherein the at least one processor is further configured to monitor for the message from the terrestrial UE based on the at least one of the PEI or the paging indication, wherein the at least one processor monitors for the message from the terrestrial UE prior to receiving the message from the terrestrial UE.

26. The apparatus of claim 15, wherein the relay node is located at an aircraft, and wherein the configuration for the search space associated with the at least one of the PEI or the paging indication is based on at least one of an operator of the aircraft, a type of the aircraft, an altitude of the aircraft, a direction of the aircraft, or a footprint region of the aircraft.

27. The apparatus of claim 15, wherein the search space corresponds to a common search space (CSS) or a dedicated search space (DSS).

28. The apparatus of claim 15, further comprising at least one of a transceiver or an antenna coupled to the at least one processor.

29. A method of wireless communication at a user equipment (UE), comprising:
receiving at least one of a paging early indication (PEI) or a paging indication based on a configuration for a search space associated with the at least one of the PEI or the paging indication; and
transmitting a message to a network node via a relay node based on the at least one of the PEI or the paging indication.

30. A method of wireless communication at a relay node, comprising:
transmitting, to a terrestrial UE, or receiving, from a non-terrestrial network (NTN) device, at least one of a paging early indication (PEI) or a paging indication based on a configuration for a search space associated with the at least one of the PEI or the paging indication;
receiving a message from the terrestrial UE based on the at least one of the PEI or the paging indication; and
relaying the message to a network node after receiving the message from the terrestrial UE.
